(19) United States
(12) Patent Application Publication
(10) Pub. No.: US 2025/0211332 A1
(43) Pub. Date: Jun. 26, 2025

(54) OPTICAL TRANSMISSION SYSTEM AND OPTICAL TRANSMISSION METHOD

(71) Applicant: NIPPON TELEGRAPH AND TELEPHONE CORPORATION, Tokyo (JP)

(72) Inventors: Akira MASUDA, Musashino-shi (JP); Shuto YAMAMOTO, Musashino-shi (JP); Masanori NAKAMURA, Musashino-shi (JP); Hiroki TANIGUCHI, Musashino-shi (JP); Mitsuteru YOSHIDA, Musashino-shi (JP); Takeshi KAKIZAKI, Musashino-shi (JP); Yoshiaki SONE, Musashino-shi (JP); Yoshiaki KISAKA, Musashino-shi (JP)

(73) Assignee: NIPPON TELEGRAPH AND TELEPHONE CORPORATION, Tokyo (JP)

(21) Appl. No.: 18/847,702

(22) PCT Filed: Apr. 7, 2022
(86) PCT No.: PCT/JP2022/017275

§ 371 Date: Sep. 17, 2024

(51) Int. Cl. H04B 10/2507

(52) U.S. Cl. CPC H04B 10/2507

(57) ABSTRACT

An optical transmission system using a transmission path for transmitting an optical signal, including: a transmitter for transmitting the optical signal; one or more optical elements for compensating deterioration of the optical signal; and a receiver for receiving the optical signal, in which a compensation amount of each of the optical element for the degradation is a predetermined amount based on a spectrum of the optical signal at a first measurement position that is a predetermined position between the transmitter and the transmission path and a spectrum of the optical signal at a second measurement position that is a predetermined position between the transmission path and the receiver.

### TECHNICAL FIELD

The present invention relates to an optical transmission system and an optical transmission method.

### BACKGROUND ART

In optical communication, an increase in the capacity of a transmission system is required with an increase in communication traffic. Therefore, in addition to an increase in bit rate with high baud rate and high multi-value modulation, a high-density wavelength multiplexing has been studied.

### CITATION LIST

### Non Patent Literature

[NPL 1] Mark Filer and Sorin Tibuleac, “Cascaded ROADM Tolerance of mQAM Optical Signals Employing Nyquist Shaping”, IEEE Photonics Conference, I P C, 2014, pp. 268-269.
[NPL 2] Jie Pan and Sorin Tibuleac, “Real-time Pre-compensation of ROADM Filtering using a Generalized Pre-emphasis Filter”, IEEE Photonics Conference, I P C, 2016, pp. 548-549
[NPL 3] Zichuan Zhou, et. al., “Impact of Analog and Digital Pre-Emphasis on the Signal-to-Noise Ratio of Bandwidth-Limited Optical Transceivers”, IEEE Photonics Journal, vol. 12, No. 2, April 2020.

### SUMMARY OF INVENTION

### Technical Problem

However, in the technique of mass transmission proposed so far, signal deterioration may be increased due to the influence of pass-band narrowing (PBN) occurring when optical relay nodes connected in multiple stages are passed through a transmission path.

As a technique for compensating the deteriorated signal waveform, there is a technique in which a compensation circuit (digital signal processing circuit) of either an optical transmitter or an optical receiver imparts inverse characteristics of transmission characteristics to a signal. However, in such a signal compensation, when the digital signal processing circuit of the optical transmitter has emphasized the high frequency region of the signal, rising of the signal waveform becomes steep and the overshoot of the signal waveform increases.

In such a case, the optical signal is greatly affected by signal waveform deterioration caused by electrical noise and nonlinear response in the optical transmitter and signal waveform deterioration caused by optical noise in the optical relay node. As a result, sometimes the peak-to-average power ratio (PAPR) of the signal waveform may become large.

In this way, when the deterioration of the signal caused by the PBN is electrically compensated, there is a case where a new deterioration of the optical signal occurs as a result of the compensation. Further, such a situation is common to not only optical communication in which deterioration of an optical signal caused by PBN is electrically compensated, but also optical communication in which deterioration of an optical signal caused in a transmission path is electrically compensated.

In view of the above circumstances, an object of the present invention is to provide a technique for suppressing deterioration of an optical signal.

### Solution to Problem

An aspect of the present invention is an optical transmission system using a transmission path for transmitting an optical signal including a transmitter for transmitting the optical signal, one or more optical elements for compensating deterioration of the optical signal, and a receiver for receiving the optical signal, in which a compensation amount of each of the optical element for the degradation is a predetermined amount based on a spectrum of the optical signal at a first measurement position that is a predetermined position between the transmitter and the transmission path and a spectrum of the optical signal at a second measurement position that is a predetermined position between the transmission path and the receiver.

An aspect of the present invention is an optical transmission method using an optical transmission system that includes a transmission path for transmitting an optical signal, the system including: a transmitter for transmitting the optical signal; one or more optical elements for compensating for deterioration of the optical signal; and a receiver for receiving the optical signal, and the method including the steps of: transmitting the optical signal with the transmitter; compensating deterioration of the optical signal with the optical element; and receiving the optical signal with the receiver; in which a compensation amount of each of the optical elements for the deterioration is a predetermined amount based on a spectrum of the optical signal at a first measurement position that is a determined position between the transmitter and the transmission path and a spectrum of the optical signal at a second measurement position that is a predetermined position between the transmission path and the receiver.

### Advantageous Effects of Invention

According to the present invention, it is possible to suppress deterioration of the optical signal occurring on the transmission path.

### BRIEF DESCRIPTION OF DRAWINGS

FIG. 1 shows a schematic diagram of an optical transmission system of an embodiment.

FIG. 2 shows a first schematic diagram of a compensation amount acquisition system for determining the compensation amount of a compensation unit in the embodiment.

FIG. 3 shows a second schematic diagram of a compensation amount acquisition system for acquiring the compensation amount of the compensation unit in the embodiment.

FIG. 4 shows a third schematic diagram of the compensation amount acquisition system for acquiring the compensation amount of the compensation unit in the embodiment.

FIG. 5 shows an example of a hardware configuration of an acquisition device in the embodiment.

FIG. 6 shows an example of a configuration of a control unit included in the acquisition device in the embodiment.

FIG. 7 shows an example of a setting pattern list information in the embodiment.

FIG. 8 is a flowchart showing a second example of a flow of processing executed in a compensation acquisition process in the embodiment.

FIG. 9 is a flowchart showing a second example of a flow of processing executed in a compensation acquisition process in the embodiment.

FIG. 10 is a drawing showing an example of a configuration of a transmitter in the embodiment.

FIG. 11 is a drawing showing an example of a configuration of a receiver in the embodiment.

FIG. 12 is a drawing showing an example of a configuration of a transmission path in the embodiment.

FIG. 13 is a flowchart showing an example of a flow of processing executed by the optical transmission system of the embodiment.

FIG. 14 is a diagram showing an example of an experiment result of transmission characteristics using the optical transmission system of the embodiment.

### DESCRIPTION OF EMBODIMENTS

### Embodiment

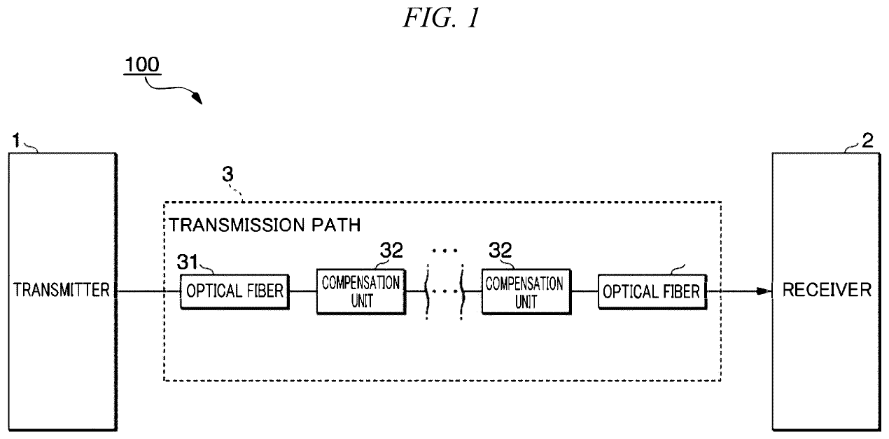

FIG. 1 shows schematically an optical transmission system 100 of the embodiment. The optical transmission system 100 performs optical communication. The optical transmission system 100 includes a transmitter 1, a receiver 2, and a transmission path 3. The transmitter 1 transmits an optical signal. The receiver 2 receives an optical signal. The transmission path 3 transmits an optical signal.

The transmission path 3 transmits the optical signal transmitted by the transmitter 1. The transmission path 3 includes optical fibers 31 and one or more compensation units 32. The optical fiber 31 transmits the optical signal input in the transmission path 3.

The compensation unit 32 compensates deterioration of the optical signal without converting the optical signal into the electric signal. The compensation amount of each compensation unit 32 with respect to the deterioration of the optical signal is a predetermined amount. The compensation amount is an amount by which the compensation unit 32 compensates for deterioration of the optical signal. Specifically, the compensation unit 32 is an optical element. Since the compensation unit 32 is the optical element, deterioration is compensated without converting the optical signal into the electric signal.

### <Setting Compensation Amount>

The compensation amount of the compensation unit 32 is a predetermined compensation amount so as to suppress deterioration of the optical signal depending on a compensation amount rule that is a predetermined rule.

Therefore, a method for determining the compensation amount of the compensation unit 32 will be described with reference to the operation of the system for determining the compensation amount of the compensation unit 32.

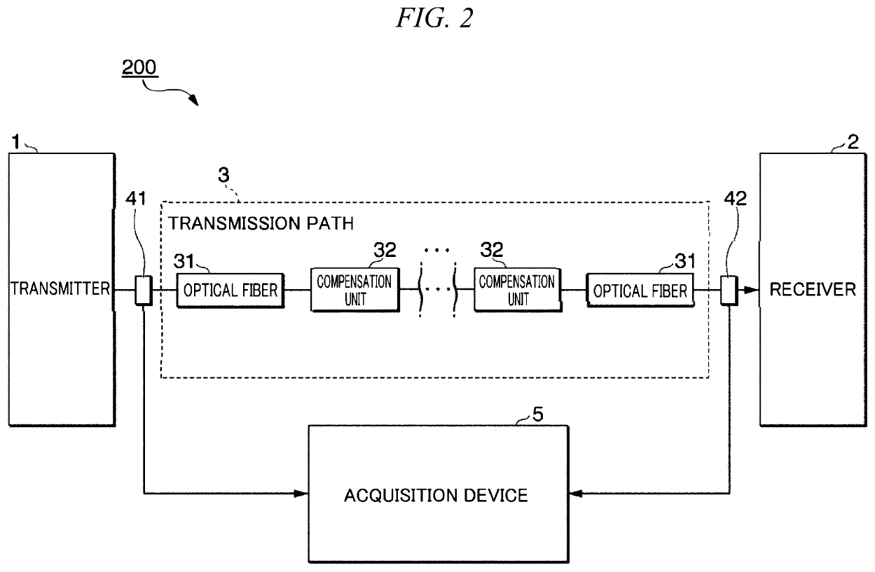

FIG. 2 shows a first schematic diagram of a compensation amount acquisition system 200 for determining the compensation amount of a compensation unit 32 in the embodiment. The compensation amount acquisition system 200 includes a transmitter 1, a receiver 2, a transmission path 3, a transmission side spectrum analyzer 41, a reception side spectrum analyzer 42, and an acquisition device 5.

The transmission side spectrum analyzer 41 measures a spectrum of an optical signal output from the transmitter 1 and before entering the transmission path 3 (hereinafter referred to as “transmission side spectrum”). The measurement result through the transmission side spectrum analyzer 41 is output to the acquisition device 5.

The reception side spectrum analyzer 42 measures a spectrum of an optical signal emitted from the transmission path 3 and before reaching the receiver 2 (hereinafter referred to as “reception side spectrum”). The measurement result through the reception side spectrum analyzer 42 is output to the acquisition device 5.

The acquisition device 5 acquires the compensation amount of the compensation unit 32 based on the transmission side spectrum and the reception side spectrum.

By the way, in measuring through the transmission side spectrum analyzer 41, the optical signal is received by the transmission side spectrum analyzer 41, so that the optical signal does not reach the reception side spectrum analyzer 42. Therefore, when the compensation unit 32 acquires the compensation amount, there are a first state period and a second state period in the compensation amount acquisition system 200.

The first state period (hereinafter referred to as “a first period”) is a period of the measurement performed by the transmission side spectrum analyzer 41. The second state period (hereinafter referred to as “a second period”) is a period of measurement performed by the reception side spectrum analyzer 42. Therefore, the first state is the state of the compensation amount acquisition system 200 in which the optical signal is received by the transmission side spectrum analyzer 41.

The first state is, for example, a state of the compensation amount acquisition system 200 in which the transmission side spectrum analyzer 41 is located between the transmitter 1 and the transmission path 3. The second state is, for example, a state of the compensation amount acquisition system 200 in which the transmission side spectrum analyzer 41 is not located between the transmitter 1 and the transmission path 3, while the reception side spectrum analyzer 42 is located between the transmission path 3 and the receiver 2.

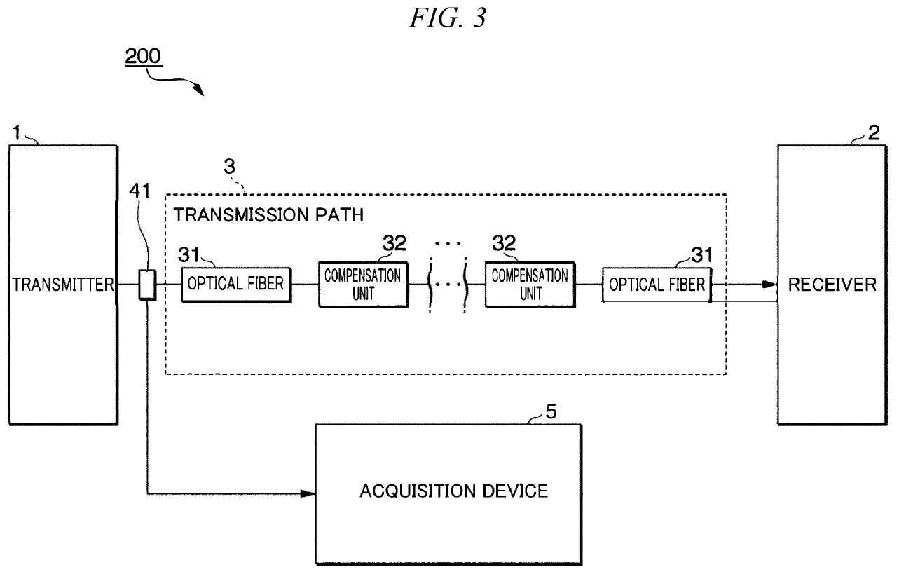

FIG. 3 shows a second schematic diagram of a compensation amount acquisition system 200 for acquiring the compensation amount of the compensation unit 32 in the embodiment. More specifically, FIG. 3 shows an example of the first state of the compensation amount acquisition system 200 in the embodiment.

In the example shown in FIG. 3, the transmission side spectrum analyzer 41 is located between the transmitter 1 and the transmission path 3. In the example shown in FIG. 3, the optical signal is received by the transmission side spectrum analyzer 41. In the example shown in FIG. 3, the transmission side spectrum analyzer 41 acquires the transmission side spectrum. On the other hand, in the example shown in FIG. 3, the reception side spectrum analyzer 42 is not located between the transmission path 3 and the receiver 2. Therefore, in the example shown in FIG. 3, the reception side spectrum analyzer 42 does not acquire the reception side spectrum.

Also in the first state, the reception side spectrum analyzer 42 may be located between the transmission path 3 and the receiver 2. Even in such a case, since the optical signal does not reach the reception side spectrum analyzer 42, the reception side spectrum analyzer 42 does not acquire the reception side spectrum.

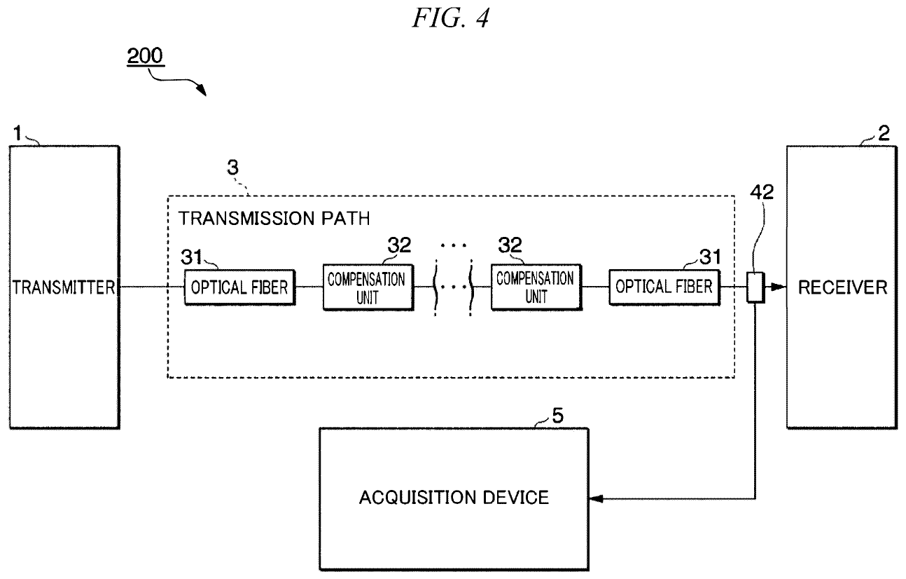

FIG. 4 shows a third schematic diagram of the compensation amount acquisition system 200 for acquiring the compensation amount of the compensation unit 32 in the embodiment. More specifically, FIG. 4 shows an example of a second state of the compensation amount acquisition system 200 in the embodiment.

In the example shown in FIG. 4, the transmission side spectrum analyzer 41 is not located between the transmitter 1 and the transmission path 3. Therefore, in the example shown in FIG. 4, the optical signal is not received by the transmission side spectrum analyzer 41. Therefore, in the example shown in FIG. 4, the transmission side spectrum analyzer 41 does not acquire the transmission side spectrum. On the other hand, in the example shown in FIG. 4, the reception side spectrum analyzer 42 is located between the transmission path 3 and the receiver 2. Therefore, in the example shown in FIG. 4, the reception side spectrum analyzer 42 acquires the reception side spectrum.

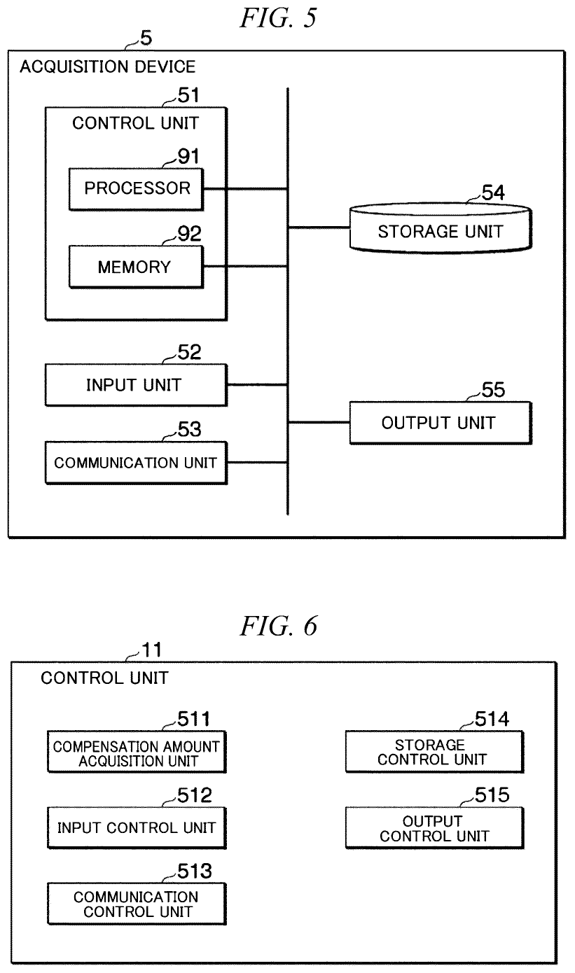

FIG. 5 shows an example of a hardware configuration of an acquisition device 5 in the embodiment.

The acquisition device 5 includes a control unit 51 including a processor 91 such as a Central Processing Unit (CPU) and a memory 92 that are connected via a bus, and executes a program. The acquisition device 5 functions by executing the program as a device including the control unit 51, an input unit 52, a communication unit 53, a storage unit 54, and an output unit 55.

More specifically, the processor 91 reads the program stored in the storage unit 54, and stores the read program in the memory 92. Since the processor 91 executes the program stored in the memory 92, the acquisition device 5 functions as a device including the control unit 51, the input unit 52, the communication unit 53, the storage unit 54, and the output unit 55.

The control unit 51 controls operations of various functional units included in the acquisition device 5. The control unit 51 controls, for example, each compensation unit 32. The control unit 51 controls, for example, each compensation unit 32, and calculates a compensation amount of each compensation unit 32 based on the transmission side spectrum and the reception side spectrum obtained as the result of the control. Hereinafter, the processing of controlling each compensation unit 32, based on the transmission side spectrum and the reception side spectrum obtained as the result of the control, the process for calculating the compensation amount from each compensation unit 32 is referred to as a compensation amount acquisition process.

Further, the control of the compensation unit 32 means, for example, moving the optical element constituting the compensation unit 32. An example of moving the optical elements constituting the compensation unit 32 is, for example, when the compensation unit 32 is a combination of a semiconductor optical amplifier and a rotational density filter, a control that causes the filter to rotate. The rotation of the filter is performed by, for example, a motor.

Therefore, in this case, the compensation unit 32 also includes a motor. In this case, the control of the compensation unit 32 means, more specifically, controlling the rotation of the motor for rotating the filter. In the case of such the compensation unit 32, for example, the intensity of the optical signal amplified by the semiconductor optical amplifier is attenuated through the rotational density filter. Therefore, the amplification degree of the optical signal through the compensation unit 32 is adjusted by the rotation of the rotational density filter.

The control of the compensation unit 32 is not necessarily required to move the optical elements constituting the compensation unit 32, for example, it may be a treatment for changing the optical constant of the optical elements such as the dielectric constant by applying heat to the optical elements constituting the compensation unit 32. In such a case, the compensation unit 32 includes a device for applying heat to the optical element. The device for applying heat to the optical element is, for example, a heater.

The optical element constituting the compensation unit 32 may be, for example, a WSS (Wavelength Selective Switch) of MEMS (Micro Electro Mechanical Systems) or a WSS of the LCOS (Liquid crystal on silicon) base.

The input unit 52 is configured to include an input device such as a mouse, a keyboard, and a touch panel. The input unit 52 may be configured as an interface for connecting these input devices to the acquisition device 5. The input unit 52 receives the input of various pieces of information for the acquisition device 5. An instruction for starting the compensation amount acquisition process is input to the input unit 52 by a user, for example.

The communication unit 53 is configured to include a communication interface for connecting the acquisition device 5 to an external device. The communication unit 53 communicates with the external device via a wire or wireless. The external device is, for example, each compensation unit 32. The external device is, for example, the transmission side spectrum analyzer 41.

The communication unit 53 acquires the transmission side spectrum by communicating with the transmission side spectrum analyzer 41. The external device is, for example, the reception side spectrum analyzer 42. The communication unit 53 acquires the reception side spectrum by communicating with the reception side spectrum analyzer 42.

The external device is, for example, the transmitter 1. The external device is, for example, the receiver 2.

The storage unit 54 is configured using a computer-readable storage medium device such as a magnetic hard disk device or a semiconductor storage device. The storage unit 54 stores various pieces of information regarding the acquisition device 5. The storage unit 54 stores, for example, the information input via the input unit 52 or the communication unit 53. The storage unit 54 stores, for example, a history of the control regarding the compensation unit 32. The storage unit 54 stores histories of the transmission side spectrum and the reception side spectrum, for example, according to the control of the compensation unit 32. The storage unit 54 stores, for example, the calculated compensation amount of each compensation unit 32.

The output unit 55 outputs various pieces of information. The output unit 15 is configured to include a display device such as, for example, a Cathode Ray Tube (CRT) display, a liquid crystal display, or an organic Electro-Luminescence (EL) display. The output unit 55 may also be configured as an interface for connecting these display devices to the acquisition device 5. The output unit 55 outputs information input to the input unit 52 or the communication unit 53, for example.

FIG. 6 is a diagram showing an example of a configuration of the control unit 51 included in the acquisition device 5 in the embodiment. The control unit 51 includes a compensation amount acquisition unit 511, an input control unit 512, a communication control unit 513, a storage control unit 514 and an output control unit 515.

The compensation amount acquisition unit 511 executes the compensation amount acquisition process. The input control unit 512 controls the operation of the input unit 52. The communication control unit 513 controls the operation of the communication unit 53. The storage control unit 514 controls the operation of the storage unit 54. The output control unit 515 controls the operation of the output unit 55.

Here, two detailed examples of the compensation amount acquisition process will be described.

### First Example of Compensation Amount Acquisition Process

In the first example of the compensation amount acquisition process, setting pattern list information is used. The setting pattern list information is information indicating a plurality of setting patterns and an order in which a control for achieving a state indicated by each setting pattern is executed in the compensation amount acquisition process. The setting pattern is information indicating a compensation amount of each compensation unit 32.

Hereinafter, for the sake of simplicity, the execution of the control for achieving the state indicated by the setting pattern will be referred to as executing the setting pattern. In the compensation amount acquisition process, each compensation unit 32 is controlled so that the compensation amount of each compensation unit 32 is the compensation amount indicated by the setting pattern. The process for controlling each compensation unit 32 so that the compensation amount of each compensation unit 32 is the compensation amount indicated by the setting pattern is the process for executing the setting pattern.

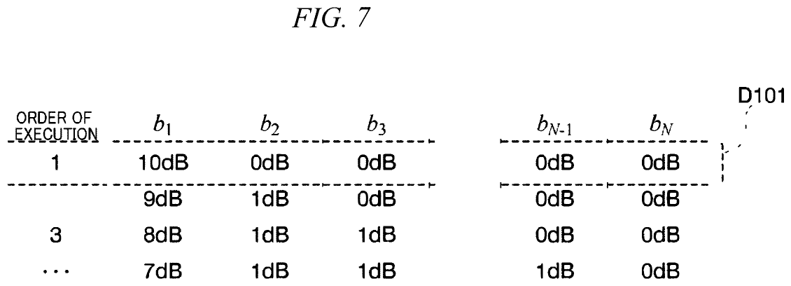

FIG. 7 is a diagram showing an example of the setting pattern list information in the embodiment. In the example shown in FIG. 7, “b₁” to “b_{N}” are respectively compensation units 32 different from each other included in the transmission path 3. The data D101 is an example among the setting patterns. The setting pattern D101 is the setting pattern to be executed first in the compensation amount acquisition process.

In the example shown in FIG. 7, the setting pattern indicates the compensation amount of each compensation unit 32. The setting pattern D101 indicates that the optical signal is controlled so as to increase by 10 dB for the compensation unit b₁ and the optical signal is controlled so as to increase by 0 dB for the compensation unit b2.

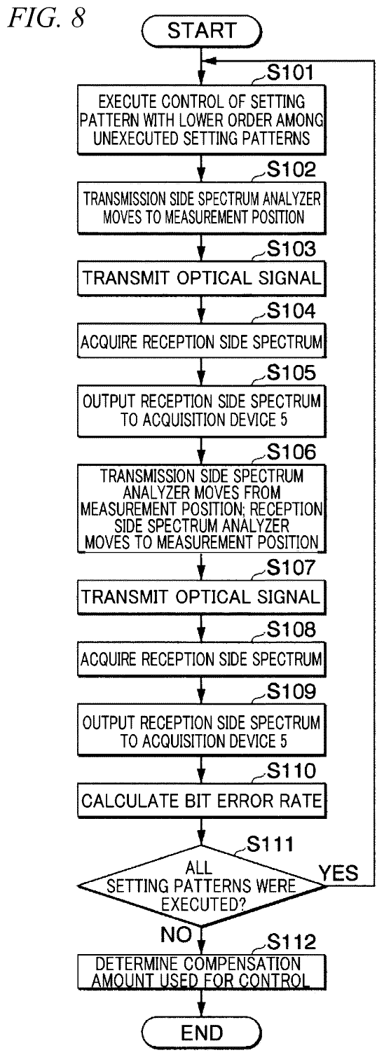

FIG. 8 is a flowchart showing a first example of a process flow executed at the compensation amount acquisition process in the embodiment. The compensation amount acquisition unit 511 executes the setting pattern with the lowest order among the unexecuted setting patterns for each compensation unit 32 via the communication unit 53 (step S101). Next, the compensation amount acquisition unit 511 controls the operation of the transmission side spectrum analyzer 41 via the communication unit 53 to move the transmission side spectrum analyzer 41 to a predetermined position between the transmitter 1 and the transmission path 3 (hereinafter referred to as “a first measurement position”) (step S102).

### An Example of the Movement Mechanism of the Transmission Side Spectrum Analyzer 41

An example of the movable transmission side spectrum analyzer 41 will be described. For example, a case where the transmission side spectrum analyzer 41 includes a piezo drive stage and a spectrum analyzer and the spectrum analyzer is located on the piezo drive stage will be described. In such a case, the transmission side spectrum analyzer 41 can move between the first measurement position and a position that is not between the transmitter 1 and the transmission path 3 by moving the piezo drive stage. Therefore, moving the transmission side spectrum analyzer 41 means moving the transmission side spectrum analyzer 41, for example, by moving the piezo drive stage.

After step S102, the compensation amount acquisition unit 511 controls the operation of the transmitter 1 via the communication unit 53, and causes the transmitter 1 to transmit the optical signal (step S103). The transmission side spectrum analyzer 41 receives the transmitted optical signal, and acquires the spectrum of the received optical signal as the transmission side spectrum (step S104). Next, the transmission side spectrum analyzer 41 outputs the acquired transmission side spectrum to the acquisition device 5 (step S105). That is, the acquisition device 5 acquires the transmission side spectrum.

Next, the compensation amount acquisition unit 511 controls the transmission side spectrum analyzer 41 and the reception side spectrum analyzer 42 via the communication unit 53, and causes each of them to move. Specifically, the compensation amount acquisition unit 511 moves the transmission side spectrum analyzer 41 from the first measurement position to a position that is not located between the transmitter 1 and the transmission path 3, and moves the reception side spectrum analyzer 42 to a second measurement position (step S106). The second measurement position is a predetermined position between the transmission path 3 and the receiver 2.

### An Example of the Movement Mechanism of the Reception Side Spectrum Analyzer 42

An example of the movable reception side spectrum analyzer 42 will be described. For example, a case where the reception side spectrum analyzer 42 includes a piezo drive stage and a spectrum analyzer and the spectrum analyzer is located on the piezo drive stage will be described. In such a case, the reception side spectrum analyzer 42 can move between the second measuring position and a position that is not between the transmission path 3 and the receiver 2 by moving the piezo drive stage. Therefore, moving the reception side spectrum analyzer 42 means moving the reception side spectrum analyzer 42, for example, by moving the piezo drive stage.

Next, the compensation amount acquisition unit 511 controls the operation of the transmitter 1 via the communication unit 53, and causes the transmitter 1 to transmit the optical signal (step S107). The reception side spectrum analyzer 42 receives the transmitted optical signal and acquires the spectrum of the received optical signal as the reception side spectrum (step S108). Next, the reception side spectrum analyzer 42 outputs the acquired reception side spectrum to the acquisition device 5 (step S109). That is, the acquisition device 5 acquires the reception side spectrum.

Next, the compensation amount acquisition unit 511 calculates a bit error rate based on the obtained transmission side spectrum and reception side spectrum (step S110). The calculated bit error rate is recorded in the storage unit 54 together with information indicating the setting pattern. Next, the compensation amount acquisition unit 511 determines whether each setting pattern is executed for all the setting patterns indicated by the setting pattern list information (step S111).

When there is a setting pattern which is not executed among the setting patterns indicated by the setting pattern list information (step S111: NO), returning to the process of the step S101.

On the other hand, when all the setting patterns indicated by the setting pattern list information are executed (step S111: YES), the compensation amount acquisition unit 511 determines a compensation amount of each compensation unit 32 indicated by a setting pattern with the lowest bit error rate as a setting compensation amount (step S112).

The setting compensation amount is an actual compensation amount of each compensation unit 32. That is, the setting compensation amount is the compensation amount of each compensation unit 32 when the optical signal transmitted by the transmitter 1 reaches the receiver 2 without being disturbed by the transmission side spectrum analyzer 41 or the reception side spectrum analyzer 42.

Therefore, the compensation amount rule in the first example of the compensation amount acquisition process is a rule for determining each compensation amount indicated by the setting pattern for minimizing the difference between the transmission side spectrum and the reception side spectrum as the actual compensation amount of each compensation unit 32 based on the setting pattern list information.

As illustrated in the flowchart of FIG. 8, all the setting patterns indicated by the setting pattern list information may be executed. Therefore, the information indicating the order in which each setting pattern is executed is not necessarily required in the compensation amount acquisition process using the setting pattern list information. Therefore, the setting pattern list information may indicate a plurality of setting patterns, and it is not necessary to indicate information indicating the order in which each setting pattern is executed. Therefore, the setting pattern list information may be information indicating a plurality of setting patterns.

The total sum of the compensation amounts of each setting pattern in the setting pattern list information is, for example, substantially coincident with a value indicating inverse characteristics of the transmission characteristics of the transmission path 3. The inverse characteristics of the transmission characteristics of the transmission path 3 is characteristics expressed by an inverse function of a function expressing the transmission characteristics of the transmission path 3.

### <Compensation>

The compensation in the optical transmission system 100 or the compensation amount acquisition system 200 is to suppress the deterioration of the shape of the spectrum, and is not necessary to compensate the power of the optical signal. Therefore, the compensation in the optical transmission system 100 or the compensation amount acquisition system 200 may be, for example, a process for passing through the filter. Even the power of the optical signal is attenuated due to the passing through the filter, if the deterioration of the shape of the spectrum is suppressed, the process for passing the optical signal through the filter is just the compensation. This is common to communications such as communications described in the NPL 1, other than the optical transmission system 100 or the compensation amount acquisition system 200.

### Second Example of the Compensation Amount Acquisition Process

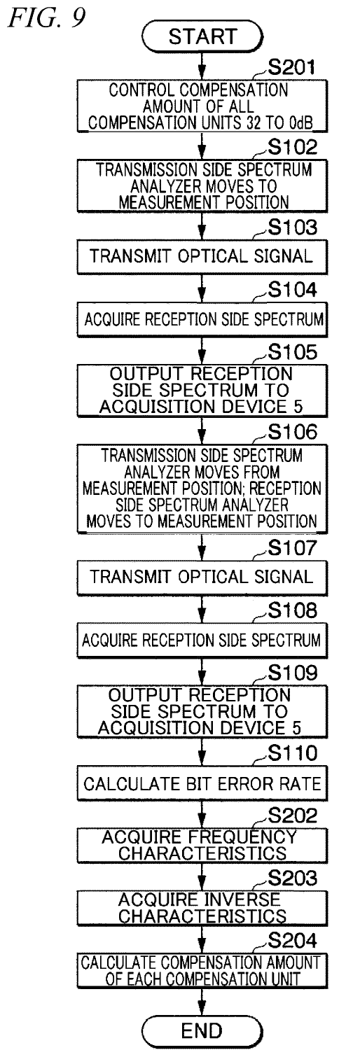

FIG. 9 is a flowchart showing a second example of a process flow executed by the compensation acquisition process in the embodiment. In FIG. 9, regarding the process similar to that in FIG. 8, by designating the same reference numerals as in FIG. 8, its description will be omitted. The compensation amount acquisition unit 511 controls all the compensation units 32 so that the compensation amounts are 0 dB (step S201). Since the compensation amounts of all the compensation units 32 are 0 dB, the process of the step S201 is the same meaning as that the compensation unit 32 does not exist in the transmission path 3.

After the process of step S201, the processes of steps S102 to S110 are executed. Next to the step S110, the compensation amount acquisition unit 511 obtains frequency characteristics C_{PBN}(f) of the transmission path 3 defined by the following equation (1) based on the obtained transmission side spectrum and the reception side spectrum (step S202). f represents a frequency.

$$[ Math . 1 ]$$

$${C}_{PBN} ( f ) = \frac{{S}_{R} ( f )}{{S}_{T} ( f )} \qquad ( 1 )$$

S_{T}(f) represents the transmission side spectrum. S_{R}(f) represents the reception side spectrum. In this way, the transmission characteristics of the transmission path 3 in which the compensation amounts of all the compensation units 32 are 0 dB are obtained based on the transmission side spectrum and the reception side spectrum through the process of the step S202.

Obtaining characteristics means obtaining information indicating characteristics. The information indicating characteristics means to obtain a value of the function representing the characteristics such as the above-mentioned function C_{PBN}(f).

Then, the compensation amount acquisition unit 511 obtains the inverse characteristics of the transmission characteristics of the transmission path 3 based on the obtained frequency characteristics C_{PBN}(f) (step S203). Specifically, with executing the process represented by the following equation (2), the inverse characteristics of the transmission characteristics of the transmission path 3 is obtained as the compensation characteristics G(f).

$$[ Math . 2 ]$$

$$G ( f ) = {{C}_{PBN} ( f )}^{- 1} \qquad ( 2 )$$

Next, a compensation amount acquisition unit 511 calculates the compensation amount of each compensation unit 32 at a predetermined distribution rate so that the total sum of the compensation amounts becomes equal to the compensation characteristics G(f) (that is, the inverse characteristics of the transmission characteristics of the transmission path 3) (step S204). The ratio of the distribution rate in the frequency direction may be the same regardless of the frequency. The compensation amount obtained in the step S204 is an example of the setting compensation amount.

In this way, in the second example of the compensation amount acquisition process, the compensation amount rule is a rule for calculating the compensation amount of each compensation unit 32 at a predetermined distribution rate so that the total sum of the compensation amounts becomes equal to the inverse characteristics of the transmission characteristics of the transmission path 3. The calculated compensation amount is used as an actual compensation amount of each compensation unit 32.

Thus, the compensation amount rule is, for example, a predetermined rule for reducing the difference between the transmission side spectrum and the reception side spectrum.

In this way, the compensation amount of each compensation unit 32 may be obtained in any way if it is obtained based on the transmission side spectrum and the reception side spectrum. Therefore, the compensation unit 32 compensates the deterioration of the signal due to the transmission path by only compensation amount determined based on the transmission side spectrum and the reception side spectrum. For example, the compensation unit 32 compensates for deterioration of the signal due to the transmission path by only compensation amount determined depending on a predetermined rule for reducing the difference between the transmission side spectrum and the reception side spectrum.

### An Example of Configuration of the Transmitter 1

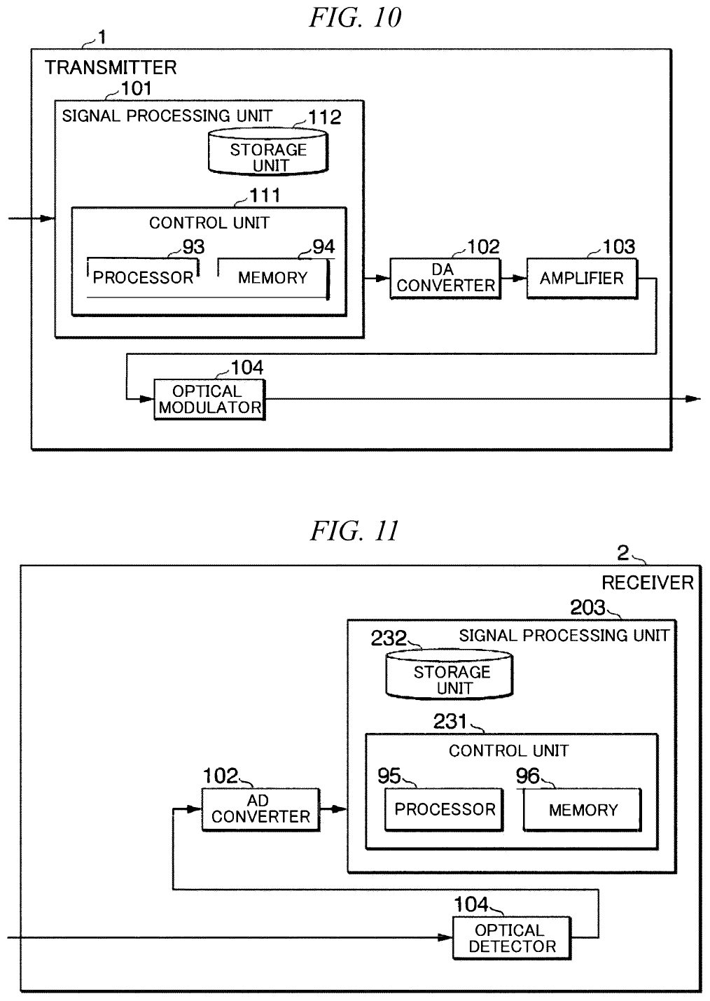

An example of the configuration of the transmitter 1 will be described. FIG. 10 is a diagram showing an example of the configuration of the transmitter 1 in the embodiment. The transmitter 1 includes a signal processing unit 101, a DA converter 102, an amplifier 103, and an optical modulator 104.

The signal processing unit 101 performs electrical signal processing. That is, the signal processing unit 101 performs a signal processing with an electrical signal. The signal processing unit 101 includes a control unit 111 including a processor 93 such as a CPU and a memory 94 connected through a bus and a storage unit 112, and executes a program.

More specifically, the processor 93 reads the program stored in the storage unit 112, and stores the read program in the memory 94. The processor 93 executes the program stored in the memory 94, so that the signal processing unit 101 functions as a device including the control unit 111 and the storage unit 112.

The control unit 111 controls operations of various functional units included in the signal processing unit 101. The control unit 111 performs the signal processing. The storage unit 112 is configured by using a computer-readable storage medium device such as a magnetic hard disk device or a semiconductor storage device. The storage unit 112 stores various information regarding the signal processing unit 101.

The DA converter 102 converts a digital signal into an analog signal. The amplifier 103 amplifies a signal. The optical modulator 104 converts an electric signal into an optical signal.

### An Example of a Configuration of the Receiver 2

An example of a configuration of the receiver 2 will be described. FIG. 11 is a diagram showing an example of a configuration of the receiver 2 in the embodiment. The receiver 2 includes an optical detector 201, an AD converter 202 and a signal processing unit 203.

The optical detector 201 converts an optical signal into an electrical signal. The AD converter 202 converts an analog signal into a digital signal.

The signal processing unit 203 performs electrical signal processing. That is, the signal processing unit 203 performs a signal processing with an electrical signal. The signal processing unit 203 includes a control unit 231 including a processor 95 such as a CPU and a memory 96 connected through a bus and a storage unit 232, and executes a program.

More specifically, the processor 95 reads the program stored in the storage unit 232, and stores the read program in the memory 96. The processor 95 executes the program stored in the memory 96, so that the signal processing unit 203 functions as a device including the control unit 231 and the storage unit 232.

The control unit 231 controls operations of various functional units included in the signal processing unit 203. The control unit 231 performs the signal processing. The storage unit 232 is configured using a computer-readable storage medium device such as a magnetic hard disk device or a semiconductor storage device. The storage unit 232 stores various information regarding the signal processing unit 203.

### An Example of a Configuration of the Transmission Path 3

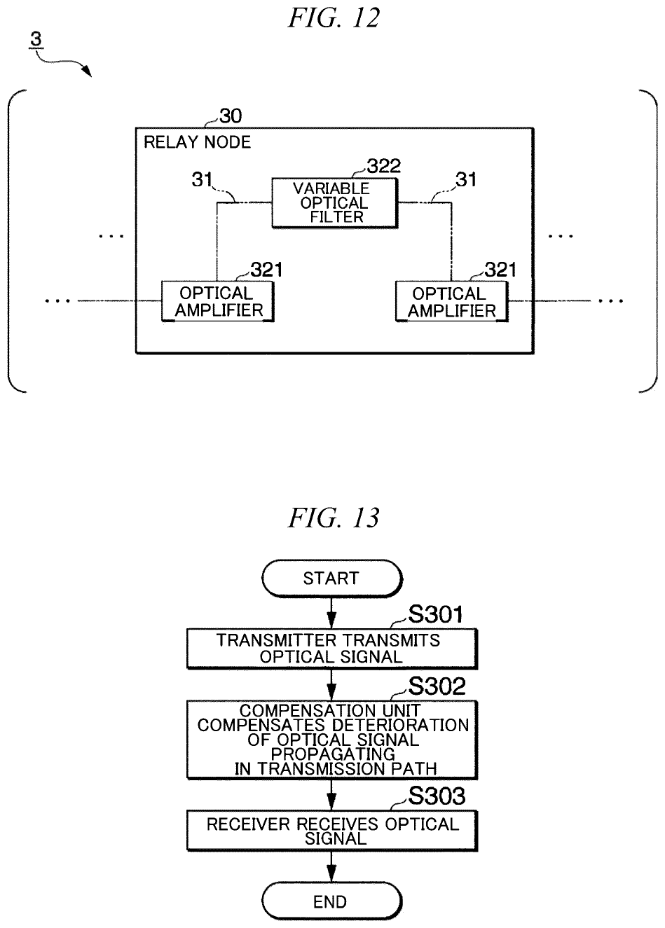

An example of the transmission path 3 will be described. FIG. 12 is a diagram showing an example of a configuration of the transmission path 3 in the embodiment. The transmission path 3 includes one or more relay nodes 30. The relay node 30 includes an optical fiber 31, an optical amplifier 321 and a variable optical filter 322. The optical amplifier 321 amplifies an optical signal. The variable optical filter 322 is, for example, an optical filter having variable transmittance such as a rotational density filter.

The optical amplifier 321 and the variable optical filter 322 are connected to each other, for example, via the optical fiber 31. The relay nodes 30 are also connected to each other, for example, via the optical fiber 31. The optical amplifier 321 and the variable optical filter 322 are both examples of the compensation unit 32, respectively.

FIG. 13 is a flowchart showing an example of a process flow that is executed by the optical transmission system 100 of the embodiment. The process of each compensation unit 32 included in the optical transmission system 100 shown in FIG. 13 has already been determined by the compensation amount acquisition process.

The transmitter 1 transmits the optical signal (step S301). Next, the compensation unit 32 compensates the deterioration of the optical signal propagating in the transmission path 3 (step S302). The receiver 2 receives the optical signal (step S303).

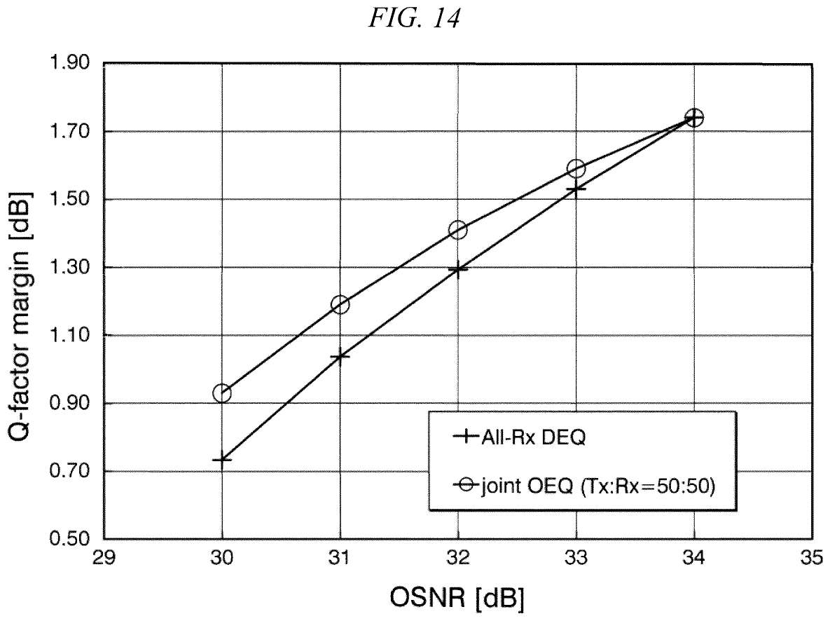

FIG. 14 is a diagram showing an example of an experiment result of transmission characteristics using the optical transmission system 100 of the embodiment. More specifically, it is the figure shows that an example of the experiment result of transmission characteristics in the case where the transmission path 3 includes two compensation units 32.

The experiment used an optical signal of 500 Gbps/A 66 Gbaud PDM-32QAM signal generated in a real-time transponder. In the experiment, the 3 dB bandwidth of the WSS (Wavelength Selective Switch) of the transmission path 3 was set to 65 GHZ in order to simulate PBN (Pass-Band Narrowing). Further, the experiment was performed in a situation where the optical signal distortion caused by the WSS of the transmission path 3 was divisionally compensated by the two WSSs of the transmission and reception ends.

In FIG. 14, the horizontal axis represents an optical signal-to-noise power ratio, and the vertical axis represents the Q-value margin from the FEC threshold. In the experiment, the optical signal was a 500 Gbps signal.

The result of the “All-Rx DEQ” represents a result of a case where converting the optical signal into an electric signal without using the compensation unit 32, the compensation was performed by the signal processing with the electric signal. The result of the “Joint OEQ (Tx:Rx=50:50)” represents a result of a case where the ratio of the compensation amounts of the two compensation units 32 is 50:50.

FIG. 14 shows that the deterioration of the signal can be suppressed the most when the ratio of the compensation amounts of the two compensation units 32 is 50:50. The unit of the compensation amount is, for example, dB. The ratio of the compensation amounts is A:B means a ratio each frequency element and that a ratio of the compensation amount of one compensation unit 32 to the compensation amount of the other compensation unit 32 is A:B.

As shown in this experiment result, the compensation amounts of the compensation units 32 may be equal to each other, for example, when the number of the compensation units 32 provided in the optical transmission system 100 is two and when the compensation amount of each compensation unit 32 is not zero.

The optical transmission system 100 of the embodiment configured in this manner performs at least a part of the compensation for the deterioration of the signal due to the transmission path with the compensation unit 32 being the optical element. Since the compensation unit 32 is the optical element, the compensation unit 32 can perform the compensation without converting the optical signal into the electric signal. Therefore, the optical transmission system 100 can suppress the deterioration of the signal caused by processing the electrical compensation such as overshoot of the signal waveform, as compared with the technique for electrically compensating the deterioration of the optical signal. Therefore, the optical transmission system 100 can suppress the deterioration of the optical signal.

Further, the compensation amount of the compensation unit 32 is the compensation amount determined based on the transmission side spectrum and the reception side spectrum in the optical transmission system 100. The transmission side spectrum is the spectrum of the optical signal at the first measurement position, and the reception side spectrum is the spectrum of the optical signal at the second measurement position.

Further, since the compensation amount of the compensation unit 32 is the compensation amount determined based on the transmission side spectrum and the reception side spectrum, it is not necessary to perform compensation in the transmitter when compensating. Although the compensation in the transmitter is only performed by the electric compensation, if the electric compensation is performed, the signal waveform deterioration caused by the overshoot of the signal waveform or the like will occur. On the other hand, in the optical transmission system 100, since the compensation amount of the compensation unit 32 is the compensation amount determined based on the transmission side spectrum and the reception side spectrum, it is not necessary to perform compensation in the transmitter. Therefore, the optical transmission system 100 can suppress the signal waveform deterioration caused by overshoot of the signal waveform or the like. As a result, the optical transmission system 100 can further suppress the deterioration of the optical signal. In addition, as a result, the optical transmission system 100 can prevent signal waveform deterioration caused by the noise enhancement, as compared with a case of compensating all in the receiver.

Therefore, the compensation amount determined based on the transmission side spectrum and the reception side spectrum is determined based on the information including only information of the deterioration of the signal caused by the transmission path 3 without including information of the deterioration of the signal caused by the transmitter 1 and the receiver 2. That is, the compensation amount of the compensation unit 32 is determined without being based on information other than the information of deterioration of the signal caused by the transmission path 3, which is information that can become noise for compensating the deterioration of the signal caused by the transmission path 3.

Therefore, the optical transmission system 100 can more effectively compensate the deterioration of the signal caused by the transmission path 3 than other systems that perform compensation without being based on the results of the first measurement position and the second measurement position. As a result, the optical transmission system 100 can further suppress the deterioration of the optical signal.

The cause of the deterioration of the signal in the transmission path 3 is, for example, PBN. The cause of the deterioration of the signal due to the transmission path 3 may be any phenomenon that occurs in the transmission path 3 and which induces the deterioration of the signal. Therefore, the cause of the deterioration of the signal due to the transmission path 3 may be, for example, band limitation, polarization dependent loss, polarization mode dispersion, wavelength dispersion, or nonlinear optical effect.

### (Variations)

The optical transmission system 100 may include the acquisition device 5, the transmission side spectrum analyzer 41 and the reception side spectrum analyzer 42. In such an optical transmission system 100, when a user performs communication using the transmission path 3, the transmission side spectrum analyzer 41 exists at a position not between the transmitter 1 and the transmission path 3, and the reception side spectrum analyzer 42 exists at a position not between the transmission path 3 and the receiver 2.

On the other hand, in such an optical transmission system 100, for example, the acquisition device 5 executes compensation amount acquisition process during a period when no user uses, and updates the compensation amount of each compensation unit 32 with adapting change of transmission characteristics of the transmission path 3 caused by usage or degradation with time.

The total sum of the compensation amounts of the compensation units 32 provided in the optical transmission system 100 may be an amount for compensating at least a part of the amount of deterioration of the optical signal, and the compensation unit 32 does not necessarily compensate for the remaining part. Therefore, the remaining part may be compensated by signal processing on the electrical signal after the optical signal has been converted into the electrical signal.

Therefore, the total sum of the compensation amounts indicated by the setting patterns of the setting pattern list information may be, for example, a condition where the larger than 0 and the smaller than a value of the inverse characteristics of the transmission characteristics of the transmission path 3.

In addition, the compensation amount of the compensation unit 32 is not necessarily a positive value, but may be a negative value. Therefore, a part among the plurality of compensation units 32 may be a positive compensation amount, and the remaining part may be a negative compensation amount. In such a case, since the degree of freedom of the compensation amount is not limited to positive and is increased, the degree of freedom of design is increased, then the possibility of suppressing deterioration of the signal is increased.

In a second example of the compensation amount acquisition process, the predetermined distribution ratio may be, for example, a distribution ratio depending on a rule where the ratio is according to a distance in which an optical signal is transmitted and in which the optical signal is transmitted without being compensated (hereinafter referred to as “non-compensation distance”).

The predetermined distribution rate according to the non-compensation distance may be, for example, a distribution rate depending on a rule where the compensation amount of the compensation unit 32 at the transmission destination is reduced as the distance in which the optical signal is transmitted and in which the optical signal is transmitted without being compensated is longer.

The compensation through the optical filter is, for example, a process of shaping a waveform with shaving a spectrum. In the case of such a process, the compensation means “giving loss”.

Therefore, if waveform shaping is further performed by the optical filter in a section having a large loss, further loss due to waveform shaping will be added. As a result, the Optical Signal to Noise Ratio (OSNR) is further deteriorated, then the signal quality will fall.

On the other hand, where the section loss is small, the amount of deterioration of the OSNR can be reduced even if compensation is performed by using an optical filter. As a result, the deterioration of the signal quality caused by the OSNR deterioration is suppressed. The section having a large loss is, for example, a long distance section in which a distance in which an optical signal is transmitted and in which the optical signal is transmitted without being compensated is long. That is, the section having a large section loss is, for example, a section having a long non-compensation distance. Therefore, the longer the non-compensation distance, the smaller the compensation amount of the compensation unit 32 at the transmission destination, so that the deterioration of the signal quality is suppressed.

The predetermined distribution rate according to the non-compensation distance may be, for example, a distribution rate depending on a rule in which the compensation amount is increased as the sum of the noise amount of the amplifier and the insertion loss of the WSS is increased.

The compensation unit 32 is not necessarily required to exist in the transmission path 3, otherwise which may be located between the transmitter 1 and the transmission path 3 or between the receiver 2 and the transmission path 3.

The acquisition device 5 need not necessarily be constituted by one housing. The acquisition device 5 may be implemented by using a plurality of information processing devices communicatively connected to each other via a network. In this case, each functional unit included in the acquisition device 5 may be implemented in the plurality of information processing devices with being distributed.

All or part of each function of the acquisition device 5 may be implemented by using a hardware such as an ASIC (Application Specific Integrated Circuit), a PLD (Programmable Logic Device), or an FPGA (Field Programmable Gate Array). The program may be recorded in a computer-readable recording medium. The computer-readable recording medium is, for example, a portable medium such as a flexible disk, a magneto optical disk, a ROM, or a CD-ROM, or a storage device such as a hard disk built in a computer system. The program may be transmitted over a telecommunication line.

Although the embodiment of the present invention has been described in detail with reference to the drawings, a specific configuration is not limited to this embodiment, and design and the like within a scope without departing from the spirit of the present invention are included.

### REFERENCE SIGNS LIST

100: Optical transmission system
200: Compensation amount acquisition system
1: Transmitter
2: Receiver
3: Transmission path
31: Optical fiber
32: Compensation unit
41: Transmission side spectrum analyzer
42: Reception side spectrum analyzer
5: Acquisition device
51: Control unit
52: Input unit
53: Communication unit
54: Storage unit
55: Output unit
511: Compensation amount acquisition unit
512: Input control unit
513: Communication control unit
514: Storage control unit
515: Output control unit
101: Signal processing unit
102: DA converter
103: Amplifier
104: Optical modulator
111: Control unit
112: Storage unit
201: Optical detector
202: AD converter
203: Signal processing unit
231: Control unit
232: Storage unit
91: Processor
92: Memory
93: Processor
94: Memory
95: Processor
96: Memory

1. An optical transmission system using a transmission path for transmitting an optical signal, comprising:
a transmitter for transmitting the optical signal;
one or more optical elements for compensating deterioration of the optical signal; and
a receiver for receiving the optical signal; wherein
a compensation amount of each of the optical elements for the deterioration is a predetermined amount based on a spectrum of the optical signal at a first measurement position that is a predetermined position between the transmitter and the transmission path, and a spectrum of the optical signal at a second measurement position that is a predetermined position between the transmission path and the receiver.

2. The optical transmission system according to claim 1, wherein
the compensation amount is a predetermined amount depending on a predetermined rule that reduces a difference between a transmission side spectrum that is a spectrum of the optical signal at the first measurement position and a reception side spectrum that is a spectrum of the optical signal at the second measurement position.

3. The optical transmission system according to claim 2, wherein
the rule is, based on setting pattern list information indicating a plurality of setting patterns corresponding to compensation amounts of each of the optical elements, a rule for determining each compensation amount indicated by the setting pattern that minimizes the difference as an actual compensation amount of each of the optical element.

4. The optical transmission system according to claim 2, wherein the rule is a rule for calculating the compensation amount of each of the optical elements at a predetermined distribution rate so that a total sum of the compensation amounts is equal to inverse characteristics of transmission characteristics of the transmission path.

5. The optical transmission system according to claim 4, wherein
the predetermined distribution rate depends on a rule in which a distribution rate is according to non-compensation distance that is a distance in which the optical signal is transmitted and in which the optical signal is transmitted without being compensated.

6. The optical transmission system according to claim 5, wherein the predetermined distribution rate is a distribution rate depending on a rule in which the longer the non-compensation distance, the smaller the compensation amount of the optical element at a transmission destination.

7. The optical transmission system according to claim 1, wherein a compensation amount of each of the optical elements is equal to each other, when the number of the optical elements is two and a compensation amount of each of the optical elements is not zero.

8. An optical transmission method performed by an optical transmission system using a transmission path for transmitting an optical signal, the system comprising: a transmitter for transmitting the optical signal; one or more optical elements for compensating for deterioration of the optical signal; and a receiver for receiving the optical signal, and the method comprising the steps of:
transmitting the optical signal with the transmitter;
compensating deterioration of the optical signal with the optical element; and
receiving the optical signal with the receiver; wherein a compensation amount of each of the optical elements for the deterioration is a predetermined amount based on a spectrum of the optical signal at a first measurement position that is a determined position between the transmitter and the transmission path and a spectrum of the optical signal at a second measurement position that is a predetermined position between the transmission path and the receiver.
